(19) United States
(12) Patent Application Publication
(10) Pub. No.: US 2025/0295101 A1
(43) Pub. Date: Sep. 25, 2025

(54) METHODS AND APPARATUS FOR PEST CONTROL

(71) Applicant: University of Connecticut, Farmington, CT (US)

(72) Inventors: Alexander Aksenov, Storrs, CT (US); Douglas Adamson, Mansfield Center, CT (US); Ali Bazzi, South Windsor, CT (US); Alexey Melnik, Storrs, CT (US); Lukasz Stelinski, Gainsville, FL (US)

(21) Appl. No.: 19/072,068

(22) Filed: Mar. 6, 2025

Related U.S. Application Data
(60) Provisional application No. 63/567,420, filed on Mar. 19, 2024.

(51) Int. Cl. A01M 1/02

(52) U.S. Cl. CPC A01M 1/026

(57) ABSTRACT

A scent generator includes a supply chamber configured for receiving a volume of an olfactory stimulant, the supply chamber including an electrically conductive foam configured to volatilize a portion of the olfactory stimulant; and a power supply configured to provide an electrical signal to the electrically conductive foam and cause the olfactory stimulant to volatilize and be ejected from the supply chamber. A pest trap using the scent generator and a computer program product for controlling the scent generator are disclosed.

### CROSS REFERENCE TO RELATED APPLICATIONS

This application claims priority to 63/567,420 filed on Mar. 19, 2024, the entire contents of which are hereby incorporated by reference.

### STATEMENT REGARDING FEDERALLY SPONSORED RESEARCH

This invention was made with government support under 2022-70029-38489 awarded by the National Institute of Food and Agriculture. The government has certain rights in the invention.

### BACKGROUND OF THE INVENTION

### 1. Field of the Invention

The invention disclosed herein relates to methods and apparatus for dispersing odors, and, in particular, to creation of odors attractive to a target organism.

### 2. Description of the Related Art

Control of insects is vital for agricultural productivity, public health, and residential comfort. Traditional methods, such as broadly acting chemical insecticides, while effective, often pose environmental risks, harm non-target species, and contribute to the development of insect resistance and include long term medical risks for consumers.

As an example, Huanglongbing (HLB), is devastating the citrus industry worldwide, causing unprecedented economic loss and harm to the food supply. According to recent data, the value of the US citrus crop alone is approximately 3 billion for the 2023-2024 season.

The Asian citrus psyllid (ACP) is the primary carrier of the bacterium associated with huanglongbing (HLB), also known as citrus greening disease. Several factors make controlling ACP challenging. For example, rapid spread is of great concern as Asian Citrus Psyllids move between host trees frequently, dispersing the pathogen quickly across orchards and regions. Early-stage detection is a problem as trees infected with HLB may remain asymptomatic for months or years, allowing psyllids to feed and spread the disease unnoticed. Repeated use of the same chemical treatments can lead to insecticide resistance, limiting the effectiveness of established pest-control methods. Psyllids can survive on ornamental and wild citrus relatives (e.g., orange jasmine), which serve as disease reservoirs and are often harder to monitor or treat.

Perhaps most problematically, growers must balance control measures with environmental regulations and concerns about beneficial insects, pollinators, and non-target organisms. That is, it is not possible to use broadly acting insecticides that will control the ACP without harming other necessary insects, such as honeybees required for pollination of the crop.

Due to these challenges, integrated approaches such as combination insecticides, biological control agents (e.g., parasitic wasps), and strict quarantine or scouting programs, are often necessary to limit ACP populations and slow HLB's spread. So far, it has not been able to control or eliminate the ACP and the inevitable spread of HLB. The two current strategies that show promise are suing tree trunk oxytetracycline antibiotic injection and use of screens to prevent seedling infection, both are unsustainable in the long term.

The Asian Citrus Psyllid (ACP) is of great concern, but it is not unique. Multiple insect pests spread bacterial pathogens in crops. Some pests resemble the Asian citrus psyllid in their role as vectors and in the difficulty of controlling their populations. Examples include the Glassy-Winged Sharpshooter. The Glassy-Winged Sharpshooter is a leafhopper which transmits Xylella fastidiosa. Xylella fastidiosa causes Pierce's disease in grapevines and several other diseases in other plants. Other leafhoppers act as vectors for Xylella strains that affect almond trees. As with the ACP, extended pesticide usage leads to resistance. Geographic expansion places new vineyards at risk.

Another example includes the Potato Psyllid. The Potato Psyllid is an insect that infests solanaceous crops and transmits Candidatus Liberibacter Solanacearum. Candidatus Liberibacter Solanacearum causes Zebra Chip disease in potatoes. Other psyllids transmit related Liberibacter species in tomato and pepper fields. Their long reproductive cycles support reinfestation. Frequent spraying increases chemical costs and fosters resistance.

Yet another example is that of the Striped Cucumber Beetle. The Striped cucumber beetle is a Coleoptera pest that attacks cucurbits and transmits Erwinia tracheiphila. Erwinia tracheiphila causes bacterial wilt in cucumbers and melons. The spotted cucumber beetle transmits the same pathogen in squash fields. Insecticide treatments lose efficacy when beetles develop resistance. Late-season infestations remain undetected until wilt appears.

Effective control of these pests often requires integrated strategies, including biological controls, monitoring programs, crop rotation, and limited chemical treatments. Each approach addresses insecticide resistance, protects beneficial insects, and reduces overall costs.

What are needed are methods and apparatus for precise targeting of specific insect species without the drawback of traditional pesticides.

### SUMMARY OF THE INVENTION

In one embodiment, a scent generator includes a supply chamber configured for receiving a volume of an olfactory stimulant, the supply chamber including an electrically conductive foam configured to volatilize a portion of the olfactory stimulant; and a power supply configured to provide an electrical signal to the electrically conductive foam and cause the olfactory stimulant to volatilize and be ejected from the supply chamber.

The olfactory stimulant may be provided as one of a fluid and in a solid form. A housing configured for housing a plurality of the supply chambers may be included. The plurality of supply chambers may be one of integrated into the housing and supplied as a plurality of replaceable cartridges. The housing may further include a mixing chamber. The mixing chamber may include a mixing device which causes discharge of the olfactory stimulant through a vent of the housing. A control system for supplying an electrical signal to the electrically conductive foam may be included. The control system may include at least one of a camera, a photonic sensor, a power supply, a power converter, a clock, a processor, memory, data storage, a bus, a temperature sensor, a moisture sensor, an acoustic sensor, a pressure sensor, a network interface, a user interface and a set of computer executable instructions. The olfactory stimulant may include at least one of fruit-derived and floral volatile organic compounds (VOC); pheromone analogs and synthetic lures; a natural substance; an essential oil; a plant extract. The electrically conductive foam may include at least one of graphene and a metallized material.

In another embodiment, a pest trap is provided. The pest trap includes a scent generator, including a plurality of supply chambers configured for receiving a volume of an olfactory stimulant, each supply chamber including an electrically conductive foam configured to volatilize a portion of a respective olfactory stimulant and cause a mixture of olfactory stimulants; and, a power supply configured to provide an electrical signal to the electrically conductive foam and cause the mixture to volatilize and be ejected from the supply chamber; and a body configured for receiving and retaining unwanted insects attracted to the pest trap by the scent generator.

A kill chamber into which the insects are drawn may be included. The kill chamber may include at least one trapping device. The at least one trapping device may include a sticky film, an interchangeable catch retainer, lighting, an auditory signal generator, and an electrostatic cage. The kill chamber may be associated with a monitoring system for monitoring efficacy of the pest trap. The monitoring system may provide monitoring information to a control system configured to adjust operation of the scent generator. The control system may be configured to adjust the operation according to training information.

In yet another embodiment, a computer program product stored on non-transitory machine readable media is provided. The computer program product includes machine executable instructions configured for controlling a scent generator by implementing a method of: receiving monitoring information regarding efficacy of a pest trap including a scent generator that includes a plurality of supply chambers, each supply chamber containing a volume of an olfactory stimulant, each the supply chamber including an electrically conductive foam configured to volatilize a portion of a respective olfactory stimulant and and cause a mixture of olfactory stimulants; and, a power supply configured to provide an electrical signal to the electrically conductive foam and cause the mixture to be ejected from the supply chamber; correlating the efficacy of the pest trap with training data; comparing ambient environmental conditions with the monitoring information and the training data; and, adjusting at least one aspect of operation of the scent generator to adjust the mixture to adjust the efficacy of the pest trap. The adjusting may include adjusting an electric signal to control a rate of volatilization of a designated olfactory stimulant. A user interface configured for at least one of set-up of the scent generator and operation of the scent generator may be provided.

### BRIEF DESCRIPTION OF THE DRAWINGS

The features and advantages of the invention are apparent from the following description taken in conjunction with the accompanying drawings in which:

FIG. 1 is an schematic diagram depicting aspects of electrical and control topology for a device for discharging an olfactory stimulant;

FIG. 2 is a schematic diagram that depicts the device of FIG. 1 in an unitary housing;

FIG. 3A is a schematic diagram that depicts of a supply chamber that contains electrically conducting foam;

FIG. 3B is a schematic diagram that depicts a cross-section of the electrically conducting foam as disposed in the supply chamber of FIG. 3A;

FIG. 4 depicts a pest trap that includes the scent generator of FIGS. 1 through 3A and 3B;

FIG. 5 depicts aspects of a control system for controlling operation of the pest trap of FIG. 4;

FIGS. 6 and 7 are graphics depicting aspects of compositions of mixtures.

### DETAILED DESCRIPTION OF THE INVENTION

Disclosed herein are methods and apparatus for generating scents of a particular character or composition. The scent generator disclosed herein may be used in a variety of settings for extended periods of time. The scent generator may include intelligence to cause adaptations as the environment into which it is disposed changes, or to adjust compositions to improve efficacy.

Generally, the scent generator may be used in a variety of environments. Examples include commercial and retail environments to flavor the ambience of the setting. Other examples include agricultural settings where attraction of pests is desired. A variety of military applications may be realized. The scent generator as introduced herein is primarily disclosed in the context of agricultural settings. This is not to be construed as limiting of the technology set forth.

Generally, the scent generator is a multi-chambered device that develops a mixture of ingredients (such as volatile organic compounds (VOC)) and ejects the mixture into the surrounding environment. Generally, each of the ingredients provides some olfactory stimulation (i.e., is an “olfactory stimulant”) for a designated type of pest. In operation, the scent generator will cause mixing of the various olfactory stimulants and ejection of the mixture into the surrounding environment. The mixture, designed to be attractive to the pest, may be used attract a surrounding population of pests to the device and lure the population into a pest trap.

Generally, as used herein, the terms “olfactory stimulant,” “volatile organic compound (VOC),” “scent,” “odor,” “flavor,” “aroma” and other similar terms all refer to compositions that are identifiable by the olfactory sense of an organism. The organism may be, for example, a human, insect, livestock or other being of interest. The particular odor generated may be used as an attractant, a repellent, for signaling and for any purpose deemed appropriate.

Generally, the olfactory stimulant may be provided in a flowable or other form suited for volatilization. That is, it should be recognized that the teachings herein may be used with fluids such as methanol which are fluid in commonly encountered ambient environmental conditions (i.e., exhibit low viscosity). Additionally, the teachings herein may be used with materials such as wax which appear as a solid in commonly encountered ambient environmental conditions (i.e., exhibit high to extremely high viscosity). Generally, it may be considered that the electrically conducting foam is configured to volatilize the olfactory stimulant. The volatilization may be, for example, through a process of evaporation and/or sublimation, and may include assisting devices such as a fan. Generally, the volatilization is controllable (controlled) as set forth below in order to introduce a desired quantity of olfactory stimulant into the ambient air.

In some embodiments, at least one of the olfactory stimulants may be supplied as a gas, such as a pressurized gas, and no electrically conducting foam is required.

Generally, a “pest” is an insect that is unwanted and may cause, directly or indirectly, damage to agricultural products. A “pest trap” generally refers to any device adapted for captivating a population of pests.

Generally, the scent generator is a device that includes a plurality of supply chambers, with each supply chamber serving as a reservoir for each of the individual olfactory stimulants. Each of the supply chambers provides a volume for each olfactory stimulant and includes a foam (discussed in detail further herein). The device also includes a mixing chamber in fluid communication with each of the supply chambers. The mixing chamber includes an exhaust port for ejection of the mixture to the external environment.

The device may used in conjunction with a pest trap for receiving each pest into a kill chamber. The kill chamber provides a volume for receiving and retaining pests attracted to the device. The kill chamber may employ any of a variety of techniques for killing the trapped population. For example, the trap may include a convoluted pathway from which it is nearly impossible to escape, a sticky pad, an electro-static device, a poison filled chamber and may employ other techniques as well as any combination of the foregoing.

In embodiments disclosed herein, the pest of interest is the Asian Citrus Psyllid (ACP), which causes “citrus greening disease,” also called Huanglongbing (HLB). The technology disclosed herein provides for combating HLB via vector control.

Generally, the device includes a plurality of chambers each of which contains an electrically conducting wicking foam (hereinafter “foam”) that is immersed in a different fluid. Each fluid contained in a chamber has a different olfactory stimulant (also referred to as an “odor”) from the other fluids contained in the other chambers. The plurality of chambers are in fluid communication with a mixing vessel where the vapors from each chamber are mixed and discharged to the environment. A controller supplies the voltage that is applied to each foam, which determines the amount of vapor discharged to the mixing vessel. The mixing vessel may contain a fan that mixes the vapors and discharges them to the surrounding environment.

A method of using the scent generator begins with filling each foam-containing chamber with olfactory stimulant (which may be the same or a different olfactory stimulant, a single compound or a mixture of compounds). An appropriate selection of olfactory stimulants is used so that the device will produce the desired scent(s). A controller for the scent generator may then be placed in set-up mode and programmed with user instructions which identify the olfactory stimulants provided along with the desired scent to be generated. The desired scent may be selected by simply selecting a desired purpose. For example, for embodiments disclosed herein, the scent will be generated to attract the Asian Citrus Psyllid (ACP).

The scent generator may be equipped for cooperation with additional components, such a pest trap, a power supply, and connected to a network. The combined device may then be transported or otherwise commissioned at a point of use for an extended duration. The user may then activate the system controller for operational mode.

Once in operational mode, the device will apply an electrical signal to each of the foam to promote evaporation of the respective stimulants. The amount of voltage applied to each foam is dependent upon the amount of the particular stimulant to be released into the environment. Stoichiometric mixtures of different vapors can thus be precisely controlled. The vapors from each foam-containing chamber are discharged to a mixing vessel, where the vapors are mixed and then discharged to the environment. In various embodiments, the mixing is accomplished by use of a mixing device such as a fan, which will also expel the mixture to the surrounding environment.

Generally, the complex mixtures of volatile organic compounds (VOCs) produced mimic natural smells that are designed to attract the designated pest, in this case the Asian Citrus Psyllid (ACP). The design and methods of operation of the device provides for mixtures that are reproducible (do not drift) and instantaneous are not possible to generate at the existing level of technology. This is mainly due to technological limitations, as it is challenging to disperse more than a few compounds in a controlled fashion.

Advantageously, the technology makes use of low-cost graphene-based sorbent materials to form VOC dispersions. The sorbent material enables delivering flexible dynamically controlled complex mixtures of VOCs for instantaneous release of individual components. Multiplexing multiple volatiles is used to generate complex volatile compound distributions. In one embodiment, the device operates in an attract-and-kill (AK) mode, effectively luring insects that pose a threat to crops or property. The insects may then be removed or redirected thus reducing the damage to the crops or property.

Generally, by maintaining separate containers for each of the olfactory stimulants, extended use of the device is made possible. That is, as each of the olfactory stimulants may degrade with time, a control system may be employed to account for changes in concentrations in each of the various olfactory stimulants and ensure adequate volume of each of the individual olfactory stimulants are delivered throughout an extended commissioning interval.

Embodiments disclosed herein are not limited to attraction of a citrus pest but can be widely defined as any application where the generation of precise and controlled smell is appropriate. This may also include generation of smells that are repulsive to a target population. Examples of applications include, but are not limited to: agricultural applications, broadly defined, including attraction or repulsion of insects, animals, and the like. Other applications may include consumer applications (such as generation of scents for enhancing entertainment experience, creating desirable smell in an environment); and for military applications.

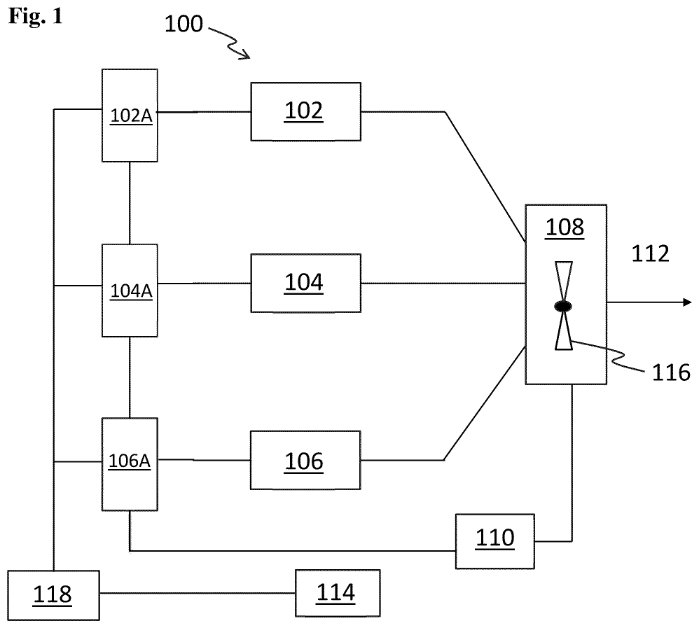

FIG. 1 is a schematic depiction of an electrical topology for a scent generator 100. Generally, the scent generator 100 includes a plurality of supply chambers 102, 104, 106, . . . (hereafter simply denoted as reference number “102”). Each supply chamber 102 may be provided with an olfactory stimulant. The olfactory stimulant in each of the supply chambers 102 may be the same as one another or may be different from those in other supply chambers 102.

The actual number of supply chambers 102 in any embodiment will depend on the implementation. There may be “n” supply chambers in a device 100, where n is an integer that may be greater than 1, greater than 6, greater than 10, and greater than 20. In an embodiment, “n” can be 50 or less. Each supply chamber 102 also contains an electrically conducting foam (referred to hereafter as “foam,” not shown). The supply chambers 102 may be provided in a variety of shapes, sizes and volumes.

Generally, each foam is disposed in a respective supply chamber and is configured to be at least partially immersed in, or imbued with, the olfactory stimulant. When placed into a respective supply chamber 102, each of the foam is in electrical communication with a power controller 102A, 104A, 106A, . . . (hereafter simply denoted as reference number “102A”). In turn, each power controller 102A is electrical communication with a system controller 110.

Each power controller 102A supplies an electrical signal (i.e., a voltage) to the foam contained in a respective one of the supply chambers 102. The application of the voltage to the foam causes the olfactory stimulant saturating the foam to volatilize and become airborne. The applied electrical signal may be in the form of direct current (DC) or alternating current (AC).

Each supply chamber is in fluid communication with a mixing chamber 108. When one or more of the supply chambers 102 contain a different olfactory stimulant from the other supply chambers, a plurality of different vapors may simultaneously or sequentially be charged to the mixing chamber 108. These different vapors get mixed in the mixing chamber 108 and discharged to the ambient atmosphere.

The mixing chamber 108 includes a mixing device 116 that mixes the vapors emanating from each supply chamber 102. The mixing device 116 may include at least one of a fan, a vibratory element, a heater and any other suitable element that will cause mixing and discharge of the mixture. Generally, the mixture includes a suitable combination of olfactory stimulants which are then discharged to the surrounding atmosphere via stream 112.

The electrical signal applied to the foam that is disposed within a respective one of the supply chambers 102 is dependent upon various factors. For example, the electrical signal may be adjusted to cause a desired flow rate or concentration of olfactory stimulant to emanate from the supply chamber 102. In some cases, it may be recognized that concentration of a particular olfactory stimulant decays with time, and therefore the electrical signal may be increased over time. That is, the electrical signal may be adjusted over time to compensate for waning concentrations of active olfactory stimulant in a given supply chamber 102, and thus use of a suitable quantity of the particular olfactory stimulant.

Generally, the electrical signal applied to each foam is controlled by a system controller 110. The system controller 110 is in electrical communication with each of the power controllers 102A and directs each power controller to supply an appropriate amount of electrical signal to the foam in each supply chamber 102 to eject a desired amount of the olfactory stimulant to the mixing chamber 108. In some embodiments, the system controller 110 is also configured to control the mixing device 116 and thus a rate of mixing and/or discharge.

The system controller 110 may include a number of devices to provide desired functionality. Included is a power supply, a power converter, a clock, a processor, memory, data storage, a bus, a network interface and a user interface. The system controller may include wireless connectivity such as Bluetooth and Wifi components. The system controller may include a hygrometer (i.e., moisture sensor), a thermometer (i.e., a temperature sensor) an acoustic sensor (for measuring sound) and an anemometer (a pressure sensor for ambient environment). The memory may include non-transitory machine-readable media useful for storing sets of computer executable instructions which may be implemented to set-up and operate the scent generator 100. The system controller 110 may also include a variety of sensors configured to monitor and observe efficacy of the operations. For example, the system controller 110 may be configured with a monitoring module that includes a camera (CCD, CMOS) and/or a photonic sensor. Examples of suitable devices for implementation as at least a part of the system controller include: Raspberry Pi, NVIDIA Jetson, Google Coral Dev Board, BeagleBone AI, Arduino Portenta H7, and OpenMV Cam H7. Specific examples include: Raspberry Pi 4 Model B; NVIDIA Jetson Nano and others.

The electrical signal may be a direct current or an alternating current voltage. Energy storage 118 may be charged by an external energy source 114 (such as from solar panels, a battery, a power grid, or a combination thereof). Generally, the energy storage 118 supplies electrical power to each of the power controllers 102A. The characteristics of the electrical signal delivered to each of the respective foams is controlled by the system controller 110.

Generally, it should be noted that graphene foam doesn't act as a simple heating device, but volatilizes compounds by other means, leading to improved attractiveness compared to the wick devices.

The foregoing provides merely one of many possible system designs. It should be understood that a variety of other embodiments may be realized and provide for the desired functionality.

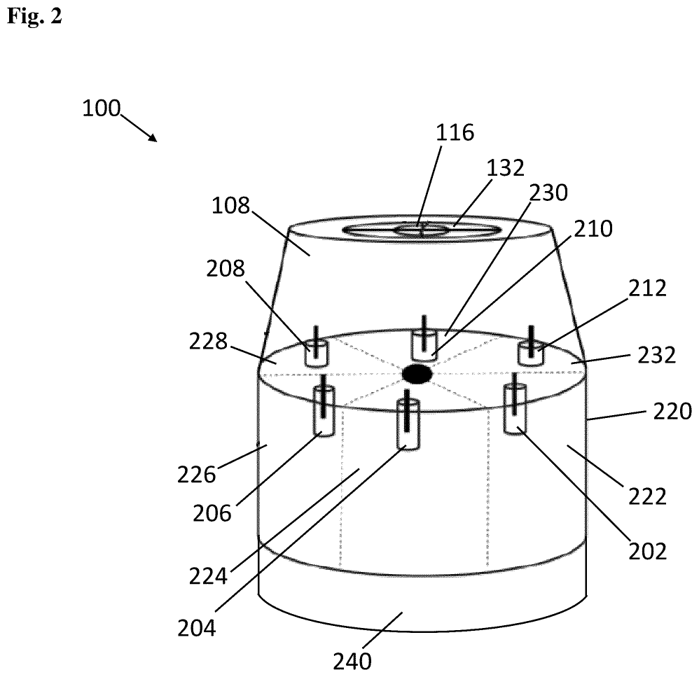

FIG. 2 depicts aspects of an embodiment of the scent generator 100. In this example, the scent generator 100 includes a unitary housing 220. The housing 220 includes a plurality of (in this case, six) compartments 222, 224, 226, 228, 230 and 232 each of which contain a respective supply chamber (in this case, six supply chambers 202, 204, 206, 208, 210 and 212). Note that hereafter, each of the supply chambers and the compartments are referenced by the first reference number in the series. That is the supply chambers are referenced by the first reference number, 202 and the compartments as 222. A system control unit 240 includes aspects of the energy storage, power supply and processing as detailed above with respect to FIG. 1. Each supply chamber 222 provides a controlled stream of olfactory stimulant to the mixing chamber 108 within the unitary housing 220. Mixing device 116 causes mixing of the various olfactory stimulants supplied to the mixing chamber 108 to provide a mixture. In this embodiment, the mixing device 116 is a fan which also causes discharge of the mixture through vent 132.

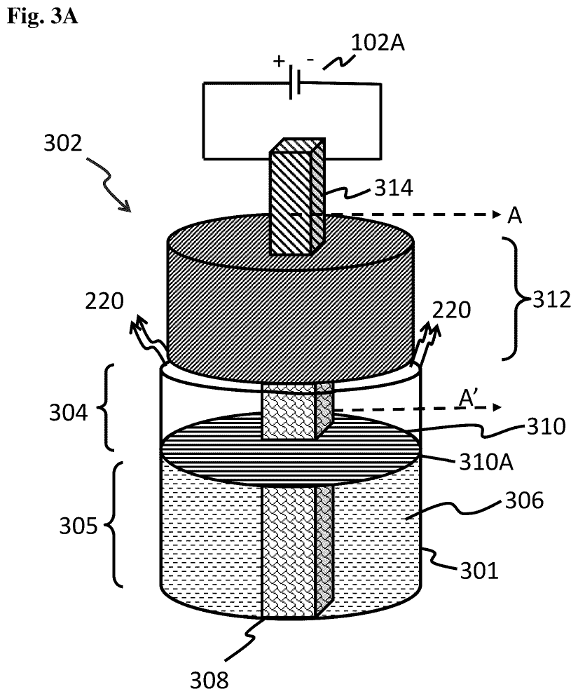

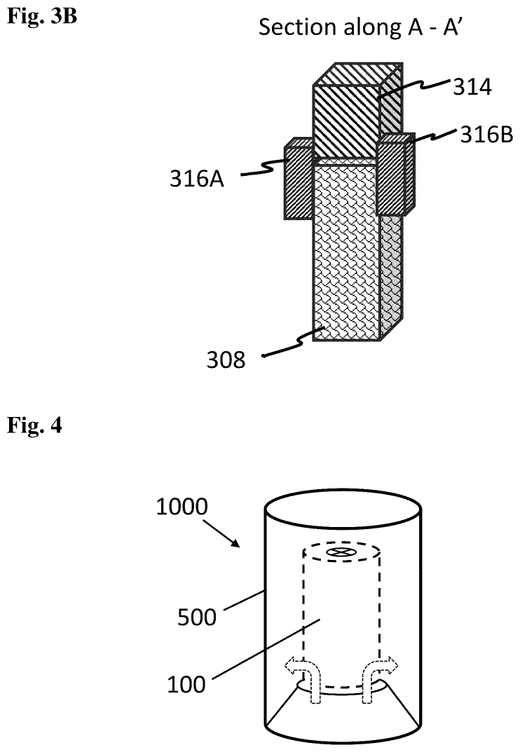

FIG. 3A is a schematic depiction of an exemplary supply chamber 302 that contains the electrically conducting foam as well as the olfactory stimulant. The supply chamber 302 includes a vessel 301 that includes a lower portion 302 and an upper portion 304. The lower portion 302 is separated from the upper portion 304 by an upper plate 310. Located below the upper plate 310 is a supply of the olfactory stimulant 306 and the electrically conducting foam 308. The electrically conducting foam 308 extends through an aperture 310A in the upper plate 310 and protrudes into the upper portion 304. In the upper portion 304, the electrically conducting foam 308 contacts an electrically insulating block 312.

In some embodiments, a single olfactory stimulant may be deployed in a supply chamber 302. In some other embodiments, a mixture of olfactory stimulants may be placed in a given supply chamber 302. In these latter embodiments, it may be desirable to include a mixture in a single supply chamber 302 for economic purposes and where the components of the mixture are generally compatible (such as where each component exhibits a similar half-life). Accordingly, it is possible to allowing to manipulate and optimize smell compositions to provide desired olfactory outcomes.

Disposed atop the upper portion 304 of the vessel 301 is the electrically insulating block 312. In this illustration, the electrically insulating block 312 supports power controller 314. The power controller 314 is in electrical communication with energy storage 118 and system controller 110 (See FIG. 1).

FIG. 3B is a depiction of the Section A to A′ from FIG. 3A, which depicts the power controller 314 that provides an electrical current to the electrically conducting foam 308 via an anode 316A and cathode 316B. The application of an electrical current facilitates a change in temperature of the electrically conducting foam 308, which will facilitate some evaporation of the olfactory stimulant that is absorbed into the electrically conducting foam 308. It is to be noted that not all of the evaporation of the olfactory stimulant from the electrically conducting foam 308 is attributable to the rise in temperature due to resistive heating of the foam 308.

FIG. 4 is an illustration of a pest trap 1000. The pest trap 1000 includes the scent generator 100 disposed within a body 500. The pest trap 1000 may be hung up or suspended in an environment where there is a prevalent population of designated pests. For example, the pest trap 1000 may be hung in a tree, or on a post next to vegetation. Insects aroused by the mixture will seek the source and find the pest trap 1000. As the insects are attracted to the mixture, the insects will find a way into the pest trap 1000. Once inside the pest trap 1000, the insects will perish there due to starvation, lack of hydration, etc. Generally, the insects will not attempt to exit from the pest trap 1000 due to the attractive nature mixture, and because of the difficulty in finding an exit from within the body 500.

Traps similar to the pest trap 1000 depicted in FIG. 4 are well-known. Accordingly, it should be recognized that a myriad of embodiments may work well with the scent generator 100. Examples of other trapping devices include those that include sticky films, interchangeable catch retainers, lighting, auditory signals, electrostatic cages and other features.

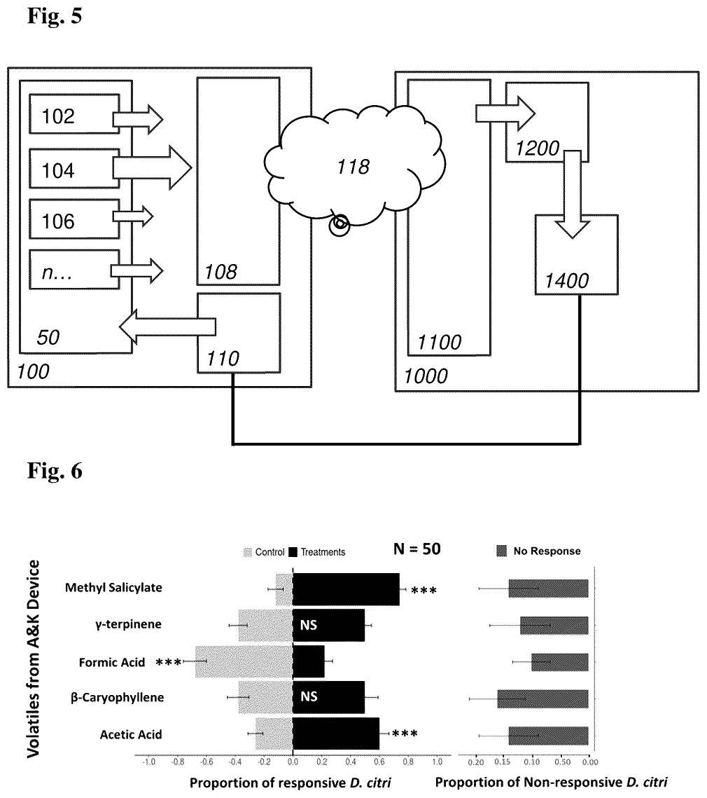

FIG. 5 is a schematic diagram that provides a logic path for control of the pest trap 1000 depicted in FIG. 4.

In FIG. 5, an embodiment of the scent generator 100 includes a plurality of supply chambers 102, 104, 106, and n. The plurality of supply chambers are collectively referred to as a set 50. As set forth above, the set of supply chambers provide olfactory stimulants to a mixing chamber 108. Mixture 118 is ejected from the mixing chamber 108. The pest trap 1000 includes a kill chamber 1100, into which insects are drawn by the mixture 118.

The pest trap 1000 includes a monitoring module 1200. Generally, the monitoring module 1200 includes components as necessary for monitoring efficacy of the pest trap 1000. For example, the monitoring module 1200 may include a camera such as a charge couple device (CCD) or complementary metal oxide semiconductor device (CMOS). One example of a suitable device is the Pixii camera. The camera may be used to monitor a canvas such as a sticky pad. In some embodiments, the camera may be used to monitor inward migration of insects through an intake port. In some embodiments, it may be adequate to use a photonic sensor that simply detects signal attenuation to count for inflow of insects. Changes in the insect population may be correlated to a particular time and thus correlated to particular formulations for the mixture 118. The monitoring module 1200 may be configured to simply count insects. In some embodiments, the monitoring module 1200 may be configured to discern types of insects. The monitoring module 1200 may further provide for monitoring of ambient conditions such as weather, temperature, humidity, time and other external factors. Generally, the monitoring module 1200 will compile information such as the rates of ingress, an assortment of external factors, and information about the nature of the insects and provide the information as monitoring information.

In this example, the monitoring module 1200 passes monitoring information to trap control unit 1400. The trap control unit 1400 may associate formulations for the mixture 118 with efficacy of the pest trap 1000 (for example, a rate of ingress into the kill chamber 1100). The trap control unit 1400 may be configured to store monitoring information in correlation with mixture information to provide a system database of training information.

Generally, the system database may be used by the trap control unit 1400 to adjust content of the mixture 118 as ambient conditions change. For example, with historic data for efficacy under varying conditions, the trap control unit 1400 may adjust formulation of the mixture 118 depending on temperature, humidity or other such factors. In some embodiments, the trap control unit 1400 implements artificial intelligence (AI) to derive appropriate formulations for the mixture 118.

A number of advantages are realized by providing a system that performs mixing at the point of use. For example, adjustments to mixtures may be made to adjust for different decay rates in the various ingredients of a given mixture. Composition of any given mixture may be adjusted to compensate for ambient conditions, such as changes in humidity, temperature and the like. With use of on-board intelligence in the form of AI, composition of the mixture may be effectively adjusted to that which demonstrates superior performance.

When the scent generator is implemented in conjunction with appropriate pest traps, it is possible to greatly reduce or eliminate use of pesticides that are expensive, environmentally persistent and toxic.

Having introduced aspects of the scent generator and a pest trap, some additional features are now set forth.

When the electrically conducting foam is immersed in the supply of olfactory stimulant within the supply chamber, the olfactory stimulant may be absorbed into the foam, such as by capillary action. When an electrical signal is applied to the foam, the electrical signal induces volatilization of the olfactory stimulant from the foam. Generally, the electrically conducting foam includes graphene and composites thereof. Advantageously, unique properties of graphene provide for sorbtion of molecules (hence wicking), and conductivity (allowing heating by applying voltage), and the material is relatively low in cost.

In some embodiments, the olfactory stimulant is provided in a solid form, such as a wax. When an electrical signal is applied to the foam, the electrical signal induces sublimation of the olfactory stimulant from the foam.

The electrically conductive foam may be provided as a foam (having open pore cells) that is manufactured from an intrinsically electrically conductive material (e.g., a metal, an intrinsically electrically conducting ceramic or polymer). The foam may be provided as an electrically insulating foam (e.g., a polymer of ceramic) where the cells are lined with a continuous layer of an electrically conducting material. The electrically conducting material may include a metal, an electrically conducting ceramic, a carbonaceous material, or a combination thereof.

In an embodiment, the foam has pores that are capable of absorbing the olfactory stimulant into the foam via capillary action, chemical compatibility, porosity and void space, or a combination thereof. Smaller pores tend to enhance capillary action. These foams may have an average cell size of 0.1 to 50 micrometers, preferably 0.5 to 20 micrometers, and more preferably 1 to 10 micrometers.

Foams that include an intrinsically electrically conducting material include metal foams, ceramic foams and polymeric foams. These embodiments of foam generally contain electrically conducting materials that do not undergo corrosion or react with the olfactory stimulant. Examples of suitable metals include aluminum, aluminum alloys, copper, copper alloys, steel, titanium, titanium alloys, nickel, nickel alloys, zinc, zinc alloys, or a combination thereof. Electrically conducting ceramic foams include indium titanium oxide, antimony tin oxide, strontium titanate (SrTiO₃), ruthenium oxide (RuO₂), transition metal carbides (e.g., TiC, ZrC, or a combination thereof), transition metal nitrides (e.g., TiN, ZrN, or a combination thereof), transition metal borides (TiB₂, ZrB₂, or a combination thereof). Combinations of the foregoing electrically conducting ceramics may be used in the electrically conducting foams. The electrically conducting foams may also comprise intrinsically electrically conducting polymers. Examples of intrinsically electrically conducting polymers that include polyacetylene, polypyrroles, polyaniline, polythiophene, or a combination thereof.

In an embodiment, the struts and walls of the foam cells may comprise a carbonaceous material. Carbonaceous materials are known to be electrically conducting. Examples of intrinsically conducting carbon foams include graphitic carbon foam, reticulated vitreous carbon foam, activated carbon foam, pyrolytic carbon foam, carbon nanotube foam, carbon aerogels, or a combination thereof.

In an embodiment, the foam may be manufactured from an electrically insulating material where the struts and walls of the open cells are coated with an electrically conductive material thus rendering the entire foam electrically conducting. The electrically insulating material serves as a substrate upon which the electrically conducting material is deposited to render the coated foam electrically conducting. In an embodiment, the aforementioned electrically conducting metals, ceramics, electrically conducting polymers, and carbon may be used to coat the insulating foam to render it electrically conducting.

In an embodiment, when the electrically insulating foam (e.g., the substrate) is coated with a metal, an electrically insulating polymeric foam having open cells may be coated with a metal via electroplating, physical vapor deposition (PVD), chemical vapor deposition/atomic layer deposition (CVD/ALD), molten metal infiltration (for high-temperature polymers).

In an embodiment, the electroplating may include electroless plating where the insulating polymer foam is surface-treated (e.g., plasma treatment or chemical roughening) to enhance adhesion. The insulating polymer foam is then pre-coated with a catalyst (e.g., palladium-tin colloids) to enable metal deposition following which it is immersed in a chemical bath containing metal ions (e.g., nickel, copper, silver), which initiates auto-catalytic deposition without using electricity. This method can advantageously be used to coat even deep, small pores due to its ability to diffuse into the structure.

In another embodiment, the electrically insulating polymeric foam may be coated using sputtering or thermal evaporation to deposit a thin metal film inside the foam in a vacuum chamber. This method produces thin, uniform coatings (e.g., coating thickness of 0.005 to 0.25 micrometers) in polymeric foams that have narrower cross-sectional areas. Table 1 below provides examples of various methods of coating electrically insulating polymeric foams along with the metals that may be used in the coating.

TABLE 1
Methods for Metallic Coating of Polymeric Foams

| | Coating | | Coating |
|---|---|---|---|
| Method | Penetration | Metal Choice | Thickness |
| Electroless | Deep (small pores) | Ni, Cu, Ag, Au | Medium |
| plating | | | (micrometers) |
| Electroplating | Moderate (if pre- | Cu, Ni, Ag, Au | Thick |
| | coated) | | (micrometers - |
| | | | millimeters) |
| PVD | Surface and shallow | Al, Ti, Cu, Ag | Thin |
| | pores | | (nanometers - |
| | | | micrometers) |
| CVD/ALD | Deep (nano-level) | Ti, W, Pt, Al | Ultrathin Thin |
| | | | (nanometers) |
| Molten metal | Deep (if sacrificial | Al, Cu, Ag | Thick |
| | | | (millimeters) |

In an embodiment, the electrically insulating foam (the substrate) may contain overlapping, non-oxidized, graphene or graphite layers or sheets disposed on the walls and struts of the open cells. The overlapping of the graphene or graphite layers produce electrically conductive pathways (percolating pathways) across the surface of the open cells to render the insulating foam electrically conducting. The electrically conducting foams used in the supply chambers may exhibit bulk electrical conductivities up to about two siemens per meter (S/m), with a compressive moduli up to about 100 megapascals (MPa) with densities as low as about 0.25 grams per square centimeter (g/cm³).

In an embodiment, the foams having the overlapping graphene or graphite layers are manufactured by creating an oil-water emulsion that contains a reactive monomer along with the graphene or graphite particles. Polymerizing the monomer (via anionic polymerization) in the oil water emulsion produces a polymeric foam with the graphene or graphite particles overlapping with one another on the surface of the open cells to produce an electrically conducting pathway. The polymeric foam forms the base structure that supports the electrically conducting carbon particles (the graphene or graphite particles) that render the foam electrically conducting.

Suitable monomers for preparing the polymeric foam includes monomers that contain polymerizable vinyl groups. In one embodiment, the vinyl group comprises an ethylenically unsaturated group. Examples of monomers that include polymerizable vinyl groups are styrene, isoprene, butyl methacrylate, divinylbenzene, methyl acrylate, tetra(ethylene glycol) diacrylate, butyl acrylate, or a combination thereof.

In some embodiments, the electrically conducting foam used in the scent generator 100 includes graphene or graphite layers disposed on a polymer manufactured from the aforementioned vinyl-containing monomers. In an embodiment, the electrically conducting foam obtained from the polymerization of the monomers in the oil-water emulsion may further be coated with one of the aforementioned electrically conducting materials (e.g., a metal, an electrically conducting ceramic or an electrically conducting polymer). In other words, the overlapping graphene or graphite particles in the foam may be coated with at least one of a metal, an electrically conducting ceramic or an electrically conducting polymer. The properties of the electrically conducting foam may thus be tailored to match the specific release profile desired for a particular fragrance.

In an embodiment, application of an electric signal to the electrically conducting foam facilitates a volatilization of the olfactory stimulant at a lower temperature than the normal volatilization temperature for the olfactory stimulant. In other words, upon application of an electric signal to the electrically conducting foam, thermal desorption of the olfactory stimulant from the electrically conducting foam occurs at a lower temperature than that normally observed. This facilitates a reduction in degradation of the olfactory stimulant thus preventing environmental contamination.

As to heating of the carbonaceous materials (used in the electrically conducting foam), the process of applying an electrical signal to carbonaceous materials for gentle heating to induce the release of olfactory stimulants involves interplay of electrical energy and material properties. Carbonaceous materials, including various forms of carbon such as activated carbon or graphene, possess unique electrical conductivity characteristics that make them ideal candidates for this application. By subjecting these materials to a controlled electrical current (either direct or alternating), a gradual heating process ensues, allowing for the subtle release of volatile organic compounds responsible for distinct olfactory sensations.

Through this method, the electrically conducting materials act as conductive pathways, efficiently transmitting the applied electrical energy and converting it into heat with precision. As the temperature rises within the material matrix, volatile organic compounds embedded within or adsorbed onto its surface begin to desorb and diffuse into the surrounding environment. This gentle heating approach ensures that the release of olfactory products is gradual and controlled, preserving their delicate aromatic profiles while avoiding thermal degradation or undesired chemical transformations.

Use of direct current for heating offers advantages in terms of energy efficiency and precise temperature control, allowing for tailored conditions conducive to the desired olfactory effect. By harnessing the electrical properties of carbonaceous materials in this manner, the process represents a sophisticated yet practical approach to eliciting specific olfactory responses, with potential applications ranging from fragrance production to sensory testing and beyond.

The amount of current provided to each electrically conducting foam in the supply chambers may depend upon the olfactory stimulant contained in each chamber and the desired rate of discharge of the particular olfactory stimulant. The controller may be used to deliver a desired amount of electrical current to the electrically conducting foam in each chamber in order to maintain a precise volumetric ratio of the olfactory stimulants to maintain a desired effect.

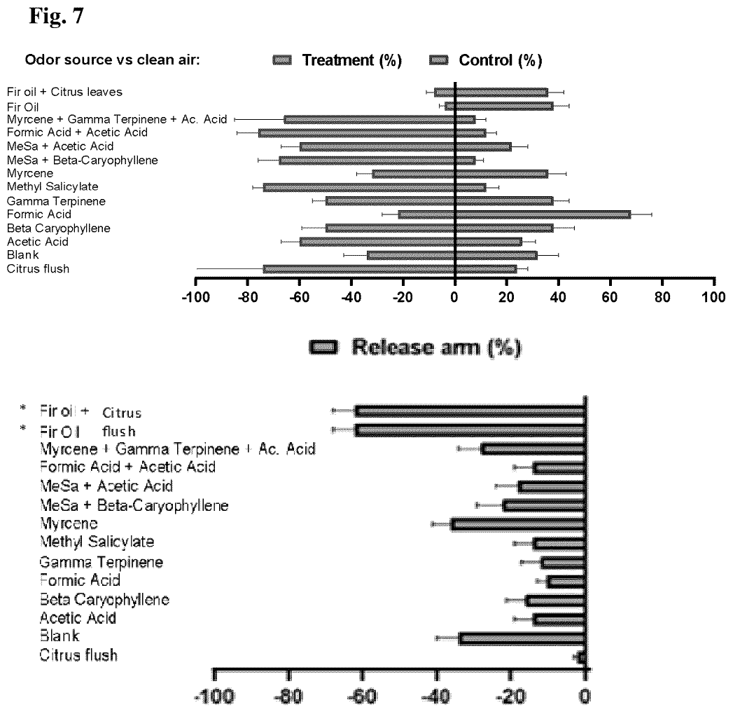

FIGS. 6 and 7 are graphics depicting response of adult female D. citri to scents of synthetic volatiles in attract and kill (AK) devices versus purified-humidified air from an air delivery system. In FIG. 7, the essential oil of A. balsameais constituted of monoterpenes (>96%) and some sesquiterpenes. β-pinene (29.9%), δ-3-carene (19.6%) and α-pinene (14.6%) are the major components.

A variety of artificial intelligence (AI) approaches may be used to deduce formulations suited for the applications introduced herein. Artificial intelligence (AI) refers to the field of computer science focused on creating intelligent machines capable of mimicking human cognitive functions. This includes tasks like learning, problem-solving, and decision-making. One powerful subfield of AI is machine learning, where algorithms can analyze data and improve their performance on a specific task without explicit programming.

AI and machine learning can be invaluable tools for Design of Experiments (DOE). Traditionally, DOE involves meticulously planning experiments to test different combinations of variables and identify optimal formulations. AI can automate this process by analyzing existing data to suggest promising formulations and predict their properties. This significantly reduces the number of physical experiments needed, saving time and resources.

Several AI models are well-suited for this purpose. Machine learning models like Gaussian Processes and Support Vector Machines can learn complex relationships between variables and desired outcomes based on existing data. Additionally, deep learning models, a type of artificial neural network inspired by the human brain, excel at finding patterns in large datasets and making predictions. These models can be particularly useful when dealing with a vast amount of formulation data and complex material properties.

Some additional models and considerations include: Optimal Experiment Design: AI models can help researchers design experiments that yield the most informative results with minimal resources. By analyzing factors, interactions, and constraints, these models suggest optimal experimental setups. For instance, they can determine the right sample size, variable settings, and control groups. Predictive Modeling: Machine learning algorithms can predict outcomes based on historical data. In experimental design, this means anticipating the impact of different variables on the response. Researchers can use regression models, decision trees, or neural networks to understand relationships and make informed decisions. Response Surface Methodology (RSM): RSM is a statistical technique used to model complex systems. AI models, such as support vector machines (SVMs) or gradient boosting, can fit response surfaces to experimental data. Researchers can then explore optimal conditions within the modeled space. Bayesian Optimization: Bayesian optimization combines probability theory and machine learning to find the best set of parameters for an experiment. It balances exploration (trying new settings) and exploitation (using known information). Gaussian processes and Bayesian neural networks are popular tools for this purpose. Deep Learning: Deep neural networks excel at handling high-dimensional data. In experimental design, they can analyze large datasets, identify hidden patterns, and optimize experimental conditions. Convolutional neural networks (CNNs) and recurrent neural networks (RNNs) are commonly used architectures. Reinforcement Learning: Although less common in experimental design, reinforcement learning (RL) can optimize sequential decision-making. Researchers can use RL to adapt experiments based on intermediate results, dynamically adjusting parameters to achieve desired outcomes.

Estimation of the electrical requirements (voltage and current) for resistive heating of a graphene-based block soaked in a volatile organic compound (VOC) is introduced. Since key parameters like the exact electrical resistance of your graphene block, the desired heating rate, and the VOC's properties (latent heat of vaporization, target temperature, etc.) are not specified, we can only outline the approach and provide example calculations.

A key step includes determining the required heat power (P). This includes estimating how much heat is needed per unit time to achieve to evaporate the VOC. The resistivity of graphene-based foams or sponges can vary dramatically depending on porosity, layer structure, doping, manufacturing methods, etc., so characterization of the foam may be completed to learn heating coefficients for each block of foam.

Various electrical power relationships may be used. P=V×I (power=voltage×current); P=I²×R (current-based form); and/or P=V²/R (voltage-based form). Using these relationships, it is possible to choose an operating voltage or current to provide the target power P given a known resistance R. It should be recognized that the geometry and resistivity of the foam can vary substantially, and therefore power needs will likewise vary substantially.

As an example, an evaporation power calculation for 0.5 mL VOC over two hours is provided.

In this example, the energy required to evaporate 0.5 mL of a volatile organic compound (VOC) over two hours (7200 seconds) is determined based on the latent heat of vaporization. The calculation proceeds as follows:
Mass of VOC. Assuming a VOC density of 0.79 g/mL, the mass (m) of 0.5 mL is:

$$m = 0.5 \times 0.79 = 0.395 g ( or = 0.000395 kg ) .$$

Energy Required for Vaporization. The latent heat of vaporization (λ) for an ethanol-like VOC is 840,000 J/kg. The total energy required for phase change is:

$$E = m \times λ = ( 0. 00395 kg ) \times ( 840 , 000 J / kg ) = 331.8 Joules$$

Power Required. The required power (PPP) for continuous evaporation over time (t) of two hours (7200 s) is then:

$$P = E / t = 331.8 Joules / 7200 seconds = 0.046 W ( or 46 mW )$$

Electrical Resistive Heating: To generate this power, an electrical signal must be applied to a resistive graphene-based heating element. The resistance (R) of the graphene material must be estimated to determine voltage and current.
Estimation of Graphene Resistivity. The sheet resistivity (p) of graphene-based foams varies depending on structure, doping, and processing. A typical resistivity for conductive graphene foams ranges from 10 mΩ·cm to 1 Ω·cm. Assuming a foam with a resistivity of 0.1 Ω·cm, and a thickness of 1 mm (0.1 cm), and a heating area of 10 cm×10 cm (100 cm²), the resistance is calculated as:

$$R = ρ \times length / area = [ ( 0.1 Ω \cdot cm ) \times ( 0.1 cm / 100 {cm}^{2} ) ] = 0.001 Ω$$

Voltage and Current Requirements. Using the power equation and solving for voltage and then current:

$$V = sqrt ( P \times R ) = s q r t [ ( 0.0 \; 46 W ) \times ( 0.0 \; 01 Ω ) ] = 0.0068 V$$

$$I = V * R = 0.0 \; 068 V * 0.001 Ω = 6.8 A$$

In summary, and for this example, the energy required: 331.8 J; Power Required: 46 mW; Resistance of the example foam structure: 1 mΩ, the voltage required is 6.8 mV and the current required: is 6.8 A. If the resistance of the graphene block is different, the voltage and current requirements will scale accordingly. Higher resistance will necessitate a higher voltage at lower current.

In some embodiments, the scent generator includes one supply chamber configured with the electrically conductive foam with a particular VOC. As such, there is no mixing chamber per se, and volatilized VOC is discharged directly to the surrounding environment.

In some embodiments, the supply chambers are refillable and may be refreshed in place. In some embodiments, the supply chambers are provided as cartridges. Depleted supply chambers may be detached from the scent generator and replacement supply chambers may be substituted. In some of these embodiments, the scent generator may include features such as a needle shaped inlet which provides for piercing a seal of the respective cartridge and subsequently receiving the olfactory stimulant. In embodiments involving cartridge style replacement supply chambers, the foam is sealed within the cartridge and electrically coupled to the scent generator by external contacts on the cartridge.

Examples of materials that may be useful in the pest trap include, without limitation: fruit-derived and floral VOCs, such as: ethyl acetate, which is commonly found in ripening fruits. Ethyl acetate often attracts fruit flies (e.g., Drosophila) and some other insects. Ethanol which is produced by fermenting fruits or other sugary materials. Ethanol can attract fruit flies, vinegar flies, and certain beetles. Acetic acid which is a byproduct of fermentation; found in vinegars and attracts various fruit flies and some wasp species. Methyl Anthranilate which is found in grapes and other fruits and can be attractive to some fruit-loving insects. Benzaldehyde which has an almond-like aroma from certain fruit pits (e.g., apricots, peaches) and can be used in traps for fruit pests, though less common than ethyl acetate or ethanol. Phenylacetaldehyde which is a floral scent compound and is known to attract some moth and butterfly species.

Other materials include pheromone analogs and synthetic lures such as methyl eugenol which is highly attractive to certain fruit flies (especially the Oriental fruit fly, Bactrocera dorsalis) and may be used in traps in agricultural pest management. Cue-Lure (4-(p-acetoxyphenyl)-2-butanone) which can be used as a specific lure for male melon flies (Bactrocera cucurbitae) and is widely used in integrated pest management. Z-9-Tricosene (Muscalure) is a sex pheromone component for houseflies (Musca domestica) and typically used in fly baits and traps.

Other natural substances can include lactic acid which can be found in human sweat; known to attract mosquitoes (in combination with CO₂) and is often paired with other attractants in mosquito traps. Ammonia or Ammonium Bicarbonate which is commonly used in traps for certain fruit flies and leafhoppers and simulates decomposing organic material. Carbon Dioxide (CO₂) which is a byproduct of respiration and attracts mosquitoes, biting midges, and various hematophagous insects. Honey, Sugar Solutions, and Molasses which are simple sweeteners that can lure generalist insects such as ants, bees, wasps, and some flies.

Some essential oils and plant extracts may be used, including geraniol (from Geraniums) which is attractive to some pollinators and may also repel certain insects (e.g., mosquitoes), so its effect can vary. Eugenol (from cloves) which is similar to methyl eugenol but not as potent for fruit fly species and has mixed effects on various insects. Limonene (from citrus peels) which has a strong citrus scent and may attract certain pests (fruit flies) while repelling others.

As stated in the Background above, a variety of crops may benefit from the technology disclosed herein. Thus, it should be noted that different insects respond to different VOCs, accordingly, the effectiveness of a particular lure depends on the concentration and the method of release (e.g., slow-release dispenser, wick, or impregnated substrate) and the target population.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. § 112 (f) interpretations as “means-plus-function” language unless specifically expressed as such by use of the words “means for” or “steps for” within the respective claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

What is claimed is:

1. A scent generator comprising:
a supply chamber configured for receiving a volume of an olfactory stimulant, the supply chamber including an electrically conductive foam configured to volatilize a portion of the olfactory stimulant;
a power supply configured to provide an electrical signal to the electrically conductive foam and cause the olfactory stimulant to volatilize and be ejected from the supply chamber.

2. The scent generator as in claim 1, wherein the olfactory stimulant is provided as one of a fluid and in a solid form.

3. The scent generator as in claim 1, further comprising a housing configured for housing a plurality of the supply chambers.

4. The scent generator as in claim 3, wherein the plurality of supply chambers is one of integrated into the housing and supplied as a plurality of replaceable cartridges.

5. The scent generator as in claim 3, wherein the housing further comprises a mixing chamber.

6. The scent generator as in claim 5, wherein the mixing chamber comprises a mixing device which causes discharge of the olfactory stimulant through a vent of the housing.

7. The scent generator as in claim 1, further comprising a control system for supplying an electrical signal to the electrically conductive foam.

8. The scent generator as in claim 7, wherein the control system comprises at least one of a camera, a photonic sensor, a power supply, a power converter, a clock, a processor, memory, data storage, a bus, a temperature sensor, a moisture sensor, an acoustic sensor, a pressure sensor, a network interface, a user interface and a set of computer executable instructions.

9. The scent generator as in claim 1, wherein the olfactory stimulant comprises at least one of fruit-derived and floral volatile organic compounds (VOC); pheromone analogs and synthetic lures; a natural substance; an essential oil; a plant extract.

10. The scent generator as in claim 1, wherein the electrically conductive foam comprises at least one of graphene and a metallized material.

11. A pest trap comprising:
a scent generator comprising a plurality of supply chambers configured for receiving a volume of an olfactory stimulant, each supply chamber including an electrically conductive foam configured to volatilize a portion of a respective olfactory stimulant and cause a mixture of olfactory stimulants; and, a power supply configured to provide an electrical signal to the electrically conductive foam and cause the mixture to volatilize and be ejected from the supply chamber; and
a body configured for receiving and retaining unwanted insects attracted to the pest trap by the scent generator.

12. The pest trap as in claim 11, comprising a kill chamber into which the insects are drawn.

13. The pest trap as in claim 12, wherein the kill chamber comprises at least one trapping device.

14. The pest trap as in claim 13, wherein the at least one trapping device comprises one of a sticky film, an interchangeable catch retainer, lighting, an auditory signal generator, and an electrostatic cage.

15. The pest trap as in claim 12, wherein the kill chamber is associated with a monitoring system for monitoring efficacy of the pest trap.

16. The pest trap as in claim 15, wherein the monitoring system provides monitoring information to a control system configured to adjust operation of the scent generator.

17. The pest trap as in claim 16, wherein the control system is configured to adjust the operation according to training information.

18. A computer program product stored on non-transitory machine readable media, the computer program product comprising machine executable instructions configured for controlling a scent generator by implementing a method of:
receiving monitoring information regarding efficacy of a pest trap comprising a scent generator comprising a plurality of supply chambers, each supply chamber comprising a volume of an olfactory stimulant, each the supply chamber including an electrically conductive foam configured to volatilize a portion of a respective olfactory stimulant and and cause a mixture of olfactory stimulants; and, a power supply configured to provide an electrical signal to the electrically conductive foam and cause the mixture to be ejected from the supply chamber;
correlating the efficacy of the pest trap with training data;
comparing ambient environmental conditions with the monitoring information and the training data; and,
adjusting at least one aspect of operation of the scent generator to adjust the mixture to adjust the efficacy of the pest trap.

19. The computer program product as in claim 18, wherein the adjusting comprises adjusting an electric signal to control a rate of volatilization of a designated olfactory stimulant.

20. The computer program product as in claim 18, further comprising a user interface configured for at least one of set-up of the scent generator and operation of the scent generator.
